(19) United States
(12) Patent Application Publication
(10) Pub. No.: US 2009/0326895 A1
(43) Pub. Date: Dec. 31, 2009

(54) TECHNIQUE AND SYSTEM FOR SEISMIC SOURCE SEPARATION

(76) Inventor: CRAIG J. BEASLEY, Houston, TX (US)

Correspondence Address: WesternGeco L.L.C.;Jeffrey E. Griffin, 10001 Richmond Avenue, HOUSTON, TX, 77042-4299, US

(21) Appl. No.: 12/165,185

(22) Filed: Jun. 30, 2008

(51) Int. Cl. G06G 7/48

(52) U.S. Cl. 703/10

(57) ABSTRACT

A technique includes obtaining first seismic data acquired by seismic sensors during a survey of a medium. The first seismic data are indicative of energy attributable to a plurality of interfering seismic sources. The technique includes generating datasets, with each dataset primarily indicating energy attributable to a different one of the seismic sources. For each seismic source, the datasets are generated as follows. The first seismic data are processed to add information to the first seismic data indicative of a geometry of the seismic source to produce second seismic data. The second seismic data is processed to perform migration based on an estimate of a geophysical model of the medium to produce migrated data. The migrated data are processed to perform reverse migration based on the estimate of the geophysical model to produce the dataset.

### BACKGROUND

The invention generally relates to a technique and system for seismic source separation.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, a technique includes obtaining first seismic data acquired by seismic sensors during a survey of a medium. The first seismic data are indicative of energy that is attributable to a plurality of interfering seismic sources. The technique includes, for a given seismic source of the seismic sources, processing the first seismic data to attenuate the indicated energy attributable to one or more seismic sources other than the given seismic source to produce second seismic data. The processing includes the following. Based a geometry of the given seismic source, an estimate of the geophysical model of the medium and the first seismic data, migration is performed to produce migrated data; and based on the geometry, the estimate of the geophysical model and the migrated data, reverse migration is performed to produce the second seismic data.

In another embodiment of the invention, a technique includes obtaining first seismic data acquired by seismic sensors during a survey of a medium. The first seismic data are indicative of energy attributable to a plurality of interfering seismic sources. The technique includes generating datasets, with each dataset primarily indicating energy that is attributable to a different one of the seismic sources. For each seismic source, the corresponding dataset is generated as follows. The first seismic data are processed to add information to the first seismic data indicative of a geometry of the seismic source to produce second seismic data. The second seismic data is processed to perform migration based on an estimate of a geophysical model of the medium to produce migrated data. The migrated data are processed to perform reverse migration based on the estimate of the geophysical model to produce the dataset.

In another embodiment of the invention, an article includes a computer readable storage medium to store instructions that when executed by a processor-based system cause the processor-based system to obtain first seismic data acquired by seismic sensors during a survey of a medium. The first seismic data are indicative of energy attributable to a plurality of interfering seismic sources. The instructions when executed by the processor-based system also cause the processor-based system to process the first seismic data to add information to the first seismic data indicative of a geometry of a given seismic source of the seismic sources to produce second seismic data. The instructions when executed by the processor-based system also cause the processor-based system to process the second seismic data to perform migration based on an estimate of a geophysical model of the medium to produce migrated data and process the migrated data to perform reverse migration based on the estimate of the geophysical model to produce a dataset, which primarily indicates energy that is attributable to the given seismic source.

In yet another embodiment of the invention, a system includes an interface and a processor. The interface obtains first seismic data acquired by seismic sensors during a survey of a medium. The first seismic data are indicative of energy attributable to a plurality of interfering seismic sources. The processor processes the first seismic data to add information to the first seismic data indicative of a geometry of a given seismic source of the seismic sources to produce second seismic data. The processor also processes the second seismic data to perform migration based on an estimate of a geophysical model of the medium to produce migrated data and processes the migrated data to perform reverse migration based on the estimate of the geophysical model to produce a dataset, which primarily indicates energy that is attributable to the given seismic source.

Advantages and other features of the invention will become apparent from the following drawing, description and claims.

### BRIEF DESCRIPTION OF THE DRAWING

FIG. 1 is a schematic diagram of a marine seismic data acquisition system according to an embodiment of the invention.

FIGS. 2 and 3 are flow diagrams depicting techniques to remove interfering source noise from acquired seismic data according to embodiments of the invention.

FIG. 4 is a schematic diagram of a seismic data processing system according to an embodiment of the invention.

### DETAILED DESCRIPTION

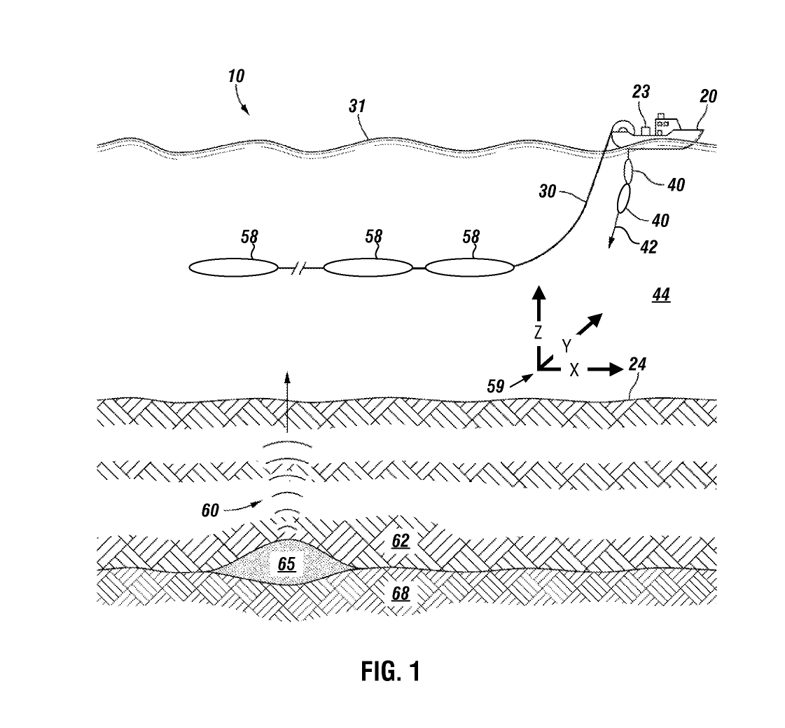

FIG. 1 depicts an embodiment 10 of a marine-based seismic data acquisition system in accordance with some embodiments of the invention. In the system 10, a survey vessel 20 tows one or more seismic streamers 30 (one exemplary streamer 30 being depicted in FIG. 1) behind the vessel 20. It is noted that the streamers 30 may be arranged in a spread in which multiple streamers 30 are towed in approximately the same plane at the same depth. As another non-limiting example, the streamers may be towed at multiple depths, such as in an over/under spread, for example.

The seismic streamers 30 may be several thousand meters long and may contain various support cables (not shown), as well as wiring and/or circuitry (not shown) that may be used to support communication along the streamers 30. In general, each streamer 30 includes a primary cable into which is mounted seismic sensors that record seismic signals. The streamers 30 contain seismic sensors 58, which may be, depending on the particular embodiment of the invention, hydrophones (as one non-limiting example) to acquire pressure data or multi-component sensors. For embodiments of the invention in which the sensors 58 are multi-component sensors (as another non-limiting example), each sensor is capable of detecting a pressure wavefield and at least one component of a particle motion that is associated with acoustic signals that are proximate to the sensor. Examples of particle motions include one or more components of a particle displacement, one or more components (inline (x), crossline (y) and vertical (z) components (see axes 59, for example)) of a particle velocity and one or more components of a particle acceleration.

Depending on the particular embodiment of the invention, the multi-component seismic sensor may include one or more hydrophones, geophones, particle displacement sensors, particle velocity sensors, accelerometers, pressure gradient sensors, or combinations thereof.

For example, in accordance with some embodiments of the invention, a particular multi-component seismic sensor may include a hydrophone for measuring pressure and three orthogonally-aligned accelerometers to measure three corresponding orthogonal components of particle velocity and/or acceleration near the sensor. It is noted that the multi-component seismic sensor may be implemented as a single device (as depicted in FIG. 1) or may be implemented as a plurality of devices, depending on the particular embodiment of the invention. A particular multi-component seismic sensor may also include pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction, and another one of the pressure gradient sensors may acquire, a particular point, seismic data indicative of the pressure data with respect to the inline direction.

The marine seismic data acquisition system 10 includes one or more seismic sources 40 (two exemplary seismic sources 40 being depicted in FIG. 1), such as air guns and the like. In some embodiments of the invention, the seismic sources 40 may be coupled to, or towed by, the survey vessel 20. Alternatively, in other embodiments of the invention, the seismic sources 40 may operate independently of the survey vessel 20, in that the sources 40 may be coupled to other vessels or buoys, as just a few examples.

As the seismic streamers 30 are towed behind the survey vessel 20, acoustic signals 42 (an exemplary acoustic signal 42 being depicted in FIG. 1), often referred to as “shots,” are produced by the seismic sources 40 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are acquired by the sources 40 produce corresponding reflected acoustic signals, or pressure waves 60, which are sensed by the seismic sensors 58. It is noted that the pressure waves that are received and sensed by the seismic sensors 58 include “up going” pressure waves that propagate to the sensors 58 without reflection, as well as “down going” pressure waves that are produced by reflections of the pressure waves 60 from an air-water boundary 31.

The seismic sensors 58 generate signals (digital signals, for example), called “traces,” which indicate the acquired measurements of the pressure wavefield and particle motion. The traces are recorded and may be at least partially processed by a signal processing unit 23 that is deployed on the survey vessel 20, in accordance with some embodiments of the invention. For example, a particular seismic sensor 58 may provide a trace, which corresponds to a measure of a pressure wavefield by its hydrophone 55; and the sensor 58 may provide (depending on the particular embodiment of the invention) one or more traces that correspond to one or more components of particle motion.

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations. Depending on the particular embodiment of the invention, portions of the analysis of the representation may be performed on the seismic survey vessel 20, such as by the signal processing unit 23. In accordance with other embodiments of the invention, the representation may be processed by a seismic data processing system (such as an exemplary seismic data processing system 320 that is depicted in FIG. 12 and is further described below) that may be, for example, located on land or on the vessel 20. Thus, many variations are possible and are within the scope of the appended claims.

A particular seismic source 40 may be formed from an array of seismic source elements (such as air guns, for example) that may be arranged in strings (gun strings, for example) of the array. Alternatively, a particular seismic source 40 may be formed from one or a predetermined number of air guns of an array, may be formed from multiple arrays, etc. Regardless of the particular composition of the seismic sources, the sources may be fired in a particular time sequence during the survey.

A conventional towed marine survey may introduce delays between successive firings of a seismic source to allow the energy that is created by a given firing to decay to an acceptable level before the energy that is associated with the next firing arrives. The use of such delays, however, imposes constraints on the rate at which the seismic data are acquired. For the towed marine survey, these delays also imply a minimum inline shot interval because the minimum speed of the survey vessel is limited.

Therefore, another type of conventional towed marine survey uses simultaneously-fired or near-simultaneously-fired seismic sources in which signals from the sources interfere for at least part of each record. This technique has greater acquisition efficiency and allows a smaller inline source sampling interval. This technique may require data processing to separate the acquired seismic data into the datasets that are each uniquely associated with one of the seismic sources.

More specifically, as described in more detail below, multiple seismic sources 40 may be fired simultaneously or near simultaneously in a short interval of time so that a composite energy signal that is sensed by the seismic sensors 58 contains a significant amount of energy from more than one seismic source 40. In other words, the seismic sources 40 interfere with each other such that the composite energy signal sensed by the seismic sensors 58 is not easily separable into signals that are attributed to the specific sources. The data that is acquired by the seismic sensors 58 is processed, as described below, to generate into datasets that are each associated with one of the seismic sources 40 so that each dataset primarily indicates the component of the composite seismic energy signal that is attributable to the associated seismic source 40.

Several techniques may be used for purposes of generating datasets, which are each uniquely associated with one of the interfering seismic sources. For example, U.S. Pat. No. 5,924,049, entitled “METHODS FOR ACQUIRING AND PROCESSING SEISMIC DATA,” which issued on Jul. 13, 1999, and are hereby incorporated by reference in the entirety discloses the use of filters for purposes of separating acquired seismic data according to source. Although relatively simple filters, such as frequency wavelength (f-k) half-plane filters (as a non-limiting example) are rather straight forward to apply, other filters involve estimating the subsurface properties (i.e., estimating a geophysical model) of the medium being surveyed. For example, three-dimensional (3-D) prestack depth migration may be used as a filter for purposes of separating the interfering sources.

To properly apply migration, however, an accurate geophysical model of the surveyed medium must either be known (obtained via a prior survey, for example) or derived from the acquired seismic data from the current survey. If the acquired seismic data are highly contaminated with interfering noise, the latter approach most likely will fail to yield an accurate geophysical model. As a result, using mere migration for purposes of source separation may be insufficient if there is no prior knowledge of the geophysical parameters of the surveyed medium.

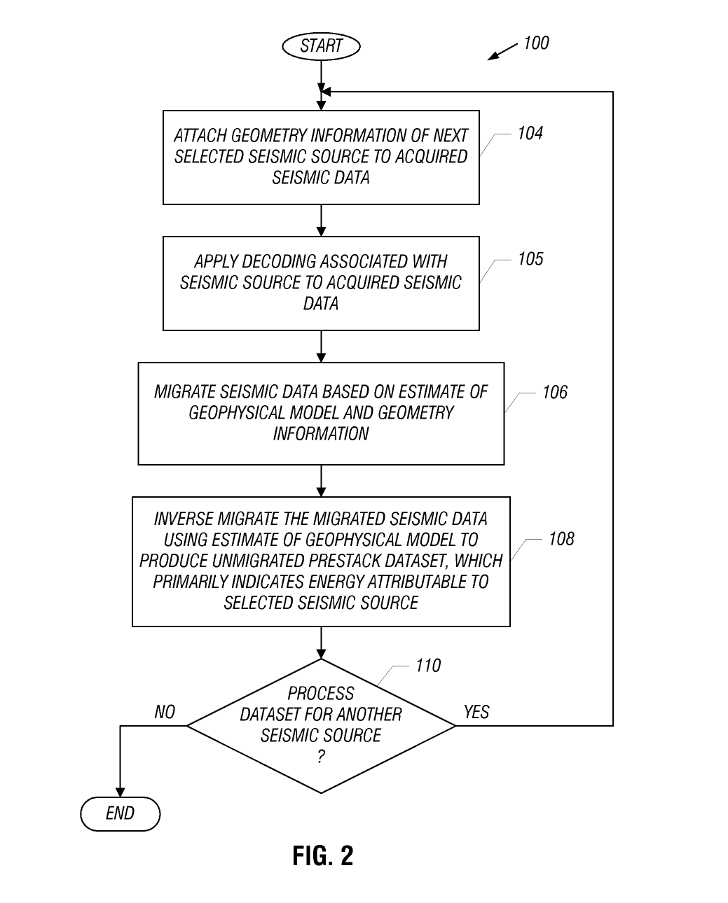

In accordance with embodiments of the invention, techniques are described herein for purposes of effectively suppressing the noise from interfering seismic sources without requiring a detailed knowledge of the subsurface (i.e., without requiring an accurate geophysical model of the subsurface. Referring to FIG. 2, more specifically, a technique 100 in accordance with embodiments of the invention involves using an estimate of a geophysical model of the subsurface for purposes of source separation. The estimate may be based on, for example, expected or approximate subsurface properties and may be significantly less accurate than the geophysical model that is used for migration-only-based source separation.

Pursuant to the technique 100, one of the interfering seismic sources is first selected (block 102) so that the acquired seismic data may be processed to suppress the noise attributable to the other seismic source(s) for purpose of producing a dataset that primarily indicates seismic energy attributable to the selected seismic source. According to the technique 100, the seismic data are processed to associate the data with the seismic source. More specifically, in accordance with some embodiments of the invention, the seismic data are processed to attach (block 104) information indicative of the geometry of the selected seismic source to the acquired seismic data. As examples, this geometry information may include the location coordinates and time of day identifiers associated with the seismic source, as described in U.S. Pat. No. 5,924,049. The seismic data may also be processed to apply decoding to the data associated with the seismic source. As examples, the seismic sources may have associated parameters, such as different times at which the sources are fired. In particular, these firings may be random or pursuant to predetermined timing pattern. Thus, decoding may include accounting for a time shift, a random time, a phase encoding, an amplitude encoding, etc., which is associated with the seismic source.

Next, pursuant to the technique 100, the seismic data (having the appended geometry information) are migrated (block 106) based on the estimate of the geophysical model. Although the migrated data may be relatively inaccurate for imaging purposes (due to the relatively imprecise geophysical model), the migration suppresses the noise, which is attributable to the other interfering seismic source(s). The technique 100 includes inversely migrating the migrated seismic data, pursuant to block 108 (using the same estimate of the geophysical model), which produces unmigrated prestack data (i.e., the dataset for the selected seismic source). Unlike the original acquired seismic data, the noise attributable to the other non-selected seismic source(s) is suppressed in the unmigrated data that is produced in block 108, as the data primarily indicates energy from the selected seismic source.

The other datasets associated with the other seismic source(s) may be generated in the same manner. Thus, pursuant to the technique 100, a determination is made (diamond 110) whether a dataset for another seismic source is to be generated. If so, the next seismic source is selected; the geometry for the next seismic source is attached, pursuant to block 104 to the seismic data; and blocks 106 and 108 are repeated.

The technique 100 may be used to generate multiple datasets, with each dataset primarily indicating the energy attributable to one of the seismic sources and with the noise from the other seismic source(s) being suppressed. Thus, source separation may be achieved without the use of a relatively accurate geophysical model.

It is noted that although FIG. 2 depicts the processing of the seismic data in a serial fashion, datasets for multiple sources may be processed in parallel in accordance with other embodiments of the invention.

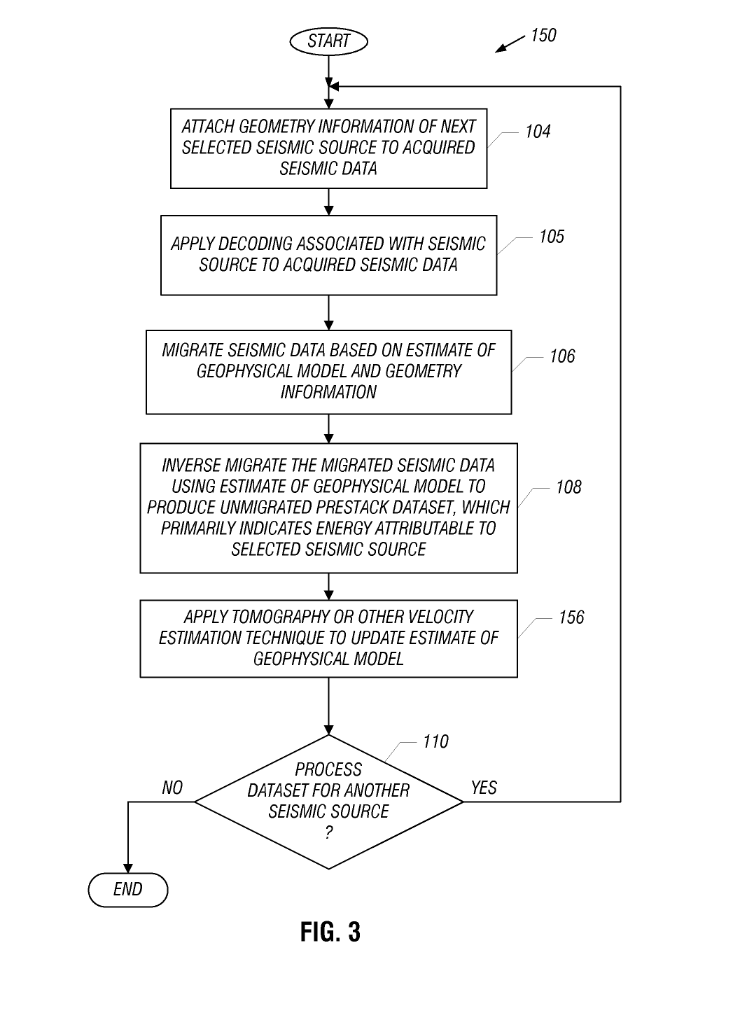

Referring to FIG. 3, as another variation, a technique 150 may be used in accordance with embodiments of the invention. The technique 150 is similar to the technique 100 (see FIG. 2) with similar reference numerals being used to identify similar acts. However, the technique 150 includes an additional block 156 related to updating the estimate of the geophysical model after each source iteration. In this regard, the technique 150 includes, after determining the dataset of unmigrated prestack data (pursuant to block 108), applying (block 156) tomography or another velocity estimation technique to update the estimate of the geophysical model based on the most recently determined seismic dataset.

Thus, in accordance with some embodiments of the invention, the source separation process may be used in an iterative fashion to refine the estimate of the geophysical model. At the conclusion of the source separation, the geophysical model may be relatively accurate and thus, may be used for other seismic data processing operations, such as deghosting, migration, etc.

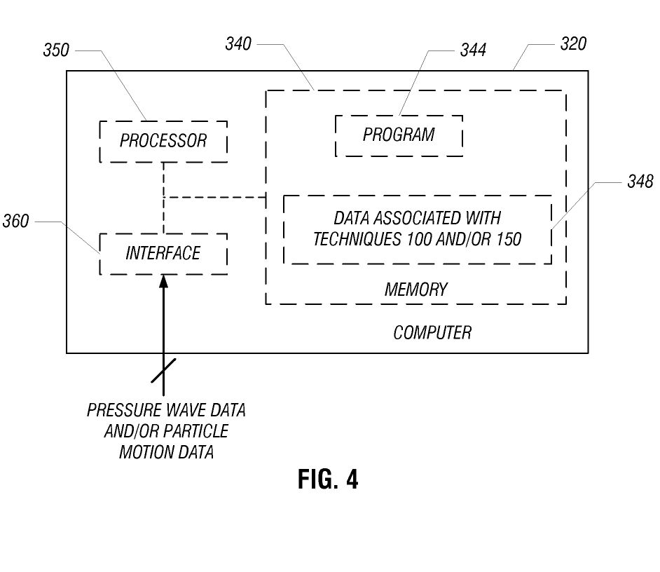

Referring to FIG. 4, in accordance with some embodiments of the invention, a seismic data processing system 320 may perform at least some of the techniques that are disclosed herein for purposes of seismic source separation. In accordance with some embodiments of the invention, the system 320 may include a processor 350, such as one or more microprocessors and/or microcontrollers. As examples, the processor 350 may be located on a streamer 30 (FIG. 1), located on the vessel 20 or located at a land-based processing facility (as examples), depending on the particular embodiment of the invention.

The processor 350 may be coupled to a communication interface 360 for purposes of receiving seismic data that corresponds to pressure and/or particle motion measurements from the seismic sensors 58. Thus, in accordance with embodiments of the invention described herein, the processor 350, when executing instructions stored in a memory of the seismic data processing system 320, may receive multi-component data and/or pressure sensor data that are acquired by seismic sensors while in tow. It is noted that, depending on the particular embodiment of the invention, the data may be data that are directly received from the sensors as the data are being acquired (for the case in which the processor 350 is part of the survey system, such as part of the vessel or streamer) or may be sensor data that were previously acquired by seismic sensors while in tow and stored and communicated to the processor 350, which may be in a land-based facility, for example.

As examples, the interface 360 may be a USB serial bus interface, a network interface, a removable media (such as a flash card, CD-ROM, etc.) interface or a magnetic storage interface (IDE or SCSI interfaces, as examples). Thus, the interface 360 may take on numerous forms, depending on the particular embodiment of the invention.

In accordance with some embodiments of the invention, the interface 360 may be coupled to a memory 340 of the seismic data processing system 320 and may store, for example, various input and/or output datasets involved with processing the seismic data in connection with the techniques 100 and 150, as indicated by reference numeral 348. The memory 340 may store program instructions 344, which when executed by the processor 350, may cause the processor 350 to perform various tasks of or more of the techniques that are disclosed herein, such as the techniques 100 and 150 and display results obtained via the technique(s) on a display (not shown in FIG. 4) of the system 320, in accordance with some embodiments of the invention.

Other embodiments are within the scope of the appended claims. For example, although a towed marine-based seismic acquisition system has been described above, the techniques and systems described herein for separating seismic signals produced by interfering seismic sources may likewise be applied to other types of seismic acquisition systems. As non-limiting examples, the techniques and system that are described herein may be applied to seabed, borehole and land-based seismic acquisition systems. Thus, the seismic sensors and sources may be stationary or may be towed, depending on the particular embodiment of the invention. As other examples of other embodiments of the invention, the seismic sensors may be multi-component sensors that acquire measurements of particle motion and pressure, or alternatively the seismic sensors may be hydrophones only, which acquire pressure measurements. Thus, many variations are contemplated and are within the scope of the appended claims.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
obtaining first seismic data acquired by seismic sensors during a survey of a medium, the first seismic data being indicative of energy attributable to a plurality of interfering seismic sources; and
for a given seismic source of the seismic sources, processing the first seismic data to attenuate the indicated energy attributable to one or more seismic sources other than the given seismic source to produce second seismic data, the processing comprising:
based on a geometry of the given seismic source, an estimate of the geophysical model of the medium and the first seismic data, performing migration to produce migrated data; and
performing reverse migration based on the geometry, the estimate of the geophysical model and the migrated data to produce the second seismic data.

2. The method of claim 1, further comprising:
updating the estimate of the model based on the second seismic data.

3. The method of claim 2, wherein the updating comprises applying a velocity estimation technique to the second seismic data.

4. The method of claim 1, further comprising:
repeating the processing of the first seismic data for another one of the seismic sources to attenuate the energy attributable to the other one or more seismic sources other than the said another seismic source to produce third seismic data.

5. The method of claim 4, further comprising:
updating the estimate of the model based on the second seismic data; and
using the updated estimate in the act of repeating for said another seismic source.

6. The method of claim 1, further comprising:
processing the first seismic data to apply decoding associated with the given seismic source.

7. A method comprising:
obtaining first seismic data acquired by seismic sensors during a survey of a medium, the first seismic data being indicative of energy attributable to a plurality of interfering seismic sources; and
generating datasets, each dataset primarily indicating energy attributable to a different one of the seismic sources, the generating comprising for each seismic source:
processing the first seismic data to add information to the first seismic data indicative of a geometry of said each seismic source to produce second seismic data;
processing the second seismic data to perform migration based on an estimate of a geophysical model of the medium to produce migrated data; and
processing the migrated data to perform reverse migration based on the estimate of the geophysical model to produce the dataset.

8. The method of claim 7, further comprising:
in response to processing the migrated data to produce the dataset for said each seismic source, updating the estimate of the geophysical model.

9. The method of claim 8, wherein the updating comprises applying a velocity estimation technique based on the dataset.

10. The method of claim 7, further comprising:
processing the generated datasets to perform deghosting, migration, and/or to determine an improved estimate of the geophysical model.

11. The method of claim 7, further comprising:
for each seismic source, processing the first seismic data to apply decoding to the first seismic data associated with the seismic source.

12. An article comprising a computer readable storage medium to store instructions that when executed by a processor-based system cause the processor-based system to:
obtain first seismic data acquired by seismic sensors during a survey of a medium, the first seismic data being indicative of energy attributable to a plurality of interfering seismic sources;
process the first seismic data to add information to the first seismic data indicative of a geometry of a given seismic source of the seismic sources to produce second seismic data;
process the second seismic data to perform migration based on an estimate of a geophysical model of the medium to produce migrated data; and
process the migrated data to perform reverse migration based on the estimate of the geophysical model to produce a dataset primarily indicating energy attributable to the given seismic source.

13. The article of claim 12, the storage medium storing instructions to cause the processor-based system to update the estimate of the geophysical model based on the dataset.

14. The article of claim 12, the storage medium storing instructions to cause the processor-based system to apply a velocity estimation technique based on the dataset to update the estimate of the geophysical model.

15. The article of claim 12, the storage medium storing instructions to cause the processor-based system to process the dataset to perform deghosting and/or migration.

16. A system comprising:
an interface to obtain first seismic data acquired by seismic sensors during a survey of a medium, the first seismic data being indicative of energy attributable to a plurality of interfering seismic sources; and
a processor to:
process the first seismic data to add information to the first seismic data indicative of a geometry of a given seismic source of the seismic sources to produce second seismic data;
process the second seismic data to perform migration based on an estimate of a geophysical model of the medium to produce migrated data; and
process the migrated data to perform reverse migration based on the estimate of the geophysical model to produce a dataset primarily indicating energy attributable to the given seismic source.

17. The system of claim 16, further comprising:
a streamer containing the seismic sensors; and
a vessel to tow the streamer.

18. The system of claim 17, wherein the processor is located on the streamer.

19. The system of claim 16, further comprising:
a land-based or seabed-based streamer containing the seismic sensors.

20. The system of claim 16, wherein the processor is adapted to update the estimate of the model based on the second seismic data.

21. The system of claim 16, wherein the processor is adapted to apply a velocity estimation technique based on the second seismic data to update the estimate of the model.

22. The system of claim 16, wherein the processor is adapted to repeat the processing of the first seismic data for another one of the seismic sources to attenuate the energy attributable to the other one or more seismic sources other than the said another seismic source to produce third seismic data.

23. The system of claim 16, wherein the processor is adapted to process the dataset to perform deghosting and/or migration.

24. The system of claim 16, wherein the processor is adapted to apply decoding to the first seismic data associated with the given seismic source.
